(19) United States
(12) Patent Application Publication
(10) Pub. No.: US 2019/0073713 A1
(43) Pub. Date: Mar. 7, 2019

(54) METHOD OF SHARING STORAGE SPACE

(71) Applicant: Austin Kim, Fresh Meadows, NY (US)

(72) Inventor: Austin Kim, Fresh Meadows, NY (US)

(21) Appl. No.: 15/693,688

(22) Filed: Sep. 1, 2017

(51) Int. Cl. G06Q 30/06; G06Q 20/10

(52) U.S. Cl. CPC G06Q 30/0645; H04L 67/10; G06Q 20/10

(57) ABSTRACT

Provided is a method of sharing a storage space. The method includes posting a storage space to a sharing platform by a space provider, connecting to the sharing platform where the space user finds the storage space by a space user, transmitting a lease request to the space provider, determining the lease request by the space provider, and making a payment by the space user. In addition, in order to post an advertisement for the storage space, the space provider may capture an image of the storage space, connects to the sharing platform where the space provider posts the storage space, input storage space information, and upload the image of the storage space.

### TECHNICAL FIELD

The present invention relates to a method of sharing a storage space, and specifically, to a method of sharing a storage space or a parking space in which a space provider posts an extra storage space of his or her property online and a space user connects to an application to search for and lease the space.

### BACKGROUND OF THE DISCLOSURE

Person-to-person sharing economy is getting popular in recent years. People can share a car through online networking or can turn unused rooms into a hotel with a room-sharing platform.

When a person moves out from a space like a dorm or a friend house and has extra items, or when a piece of furniture does not fit into a new space, a self-storage is an option to keep the extra items in a separate place. However, it is expensive to store extra items for a long time in a commercial storage space.

In addition, many people encounter difficulties while spending much time on finding a parking spot. Sometimes, it takes forever to find the spot close to a house. However, your next-door neighbor has a vacancy in his assigned parking spot all the time. When you look around a parking environment in an apartment complex in a metropolitan city, e.g., Manhattan, Seoul, or Tokyo, despite the parking spot assigned for each household, some residents are getting around to find a parking spot to park his or her second car, whereas your next-door neighbor doesn't have a car so that the neighbor's assigned space is empty all the time.

Sharing the storage space or the parking spot with someone else who is in need of the spaces for a fee might be an option for both the space provider and the space user.

### SUMMARY OF THE DISCLOSURE

A method of sharing a storage space is disclosed. The method of sharing a storage space according to an embodiment of the present invention includes posting a storage space to a sharing platform by a space provider, connecting to the sharing platform where the space user finds the storage space by a space user, transmitting a lease request to the space provider, determining the lease request by the space provider, and making a payment by the space user. In addition, in order to post an advertisement for the storage space, the space provider may capture an image of the storage space, connects to the sharing platform where the space provider posts the storage space, input storage space information, and upload the image of the storage space.

Also, the determining of the lease request involves determining whether or not the space provider accepts the lease request from the space user, determining whether or not the space provider has an additional condition for the lease request, outputting an additional condition request to the space user when the space provider has an additional condition for the lease request, and determining whether or not the space user accepts the additional condition request. A refusal decision may be outputted to the space user when the space provider does not accept the lease request from the space user.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a flow chart illustrating a method of sharing a storage space according to an embodiment of the present invention;

FIG. 2 is a flow chart illustrating a step of posting a storage space in detail according to an embodiment of the present invention;

FIG. 3 is a view illustrating a screen of a mobile device in which an application for leasing a storage space operates;

FIG. 4 is a flow chart illustrating a step of determining a lease request for a storage space in detail according to an embodiment of the present invention; and

FIG. 5 is a flow chart illustrating a step of making a payment for a storage space in detail according to an embodiment of the present invention.

### DETAILED DESCRIPTION OF THE DISCLOSURE

Preferred embodiments of the present invention will be described in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, a method of sharing a storage space according to an embodiment of the present invention will be described in detail with reference to the accompanying drawings.

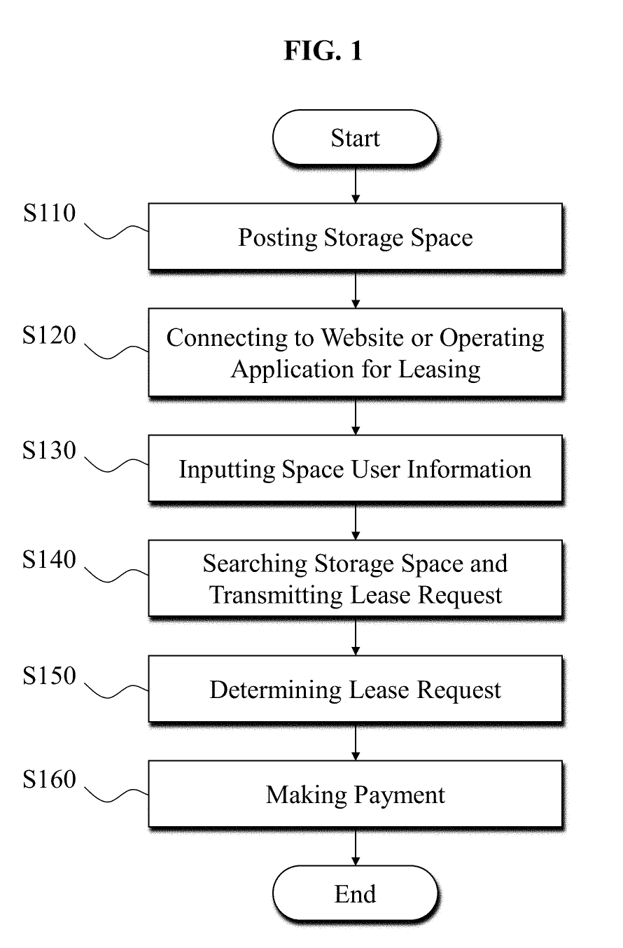

FIG. 1 is a flow chart illustrating the method of sharing a storage space according to an embodiment of the present invention. As shown in FIG. 1, the storage space may be posted in a sharing platform by a space provider at step S110.

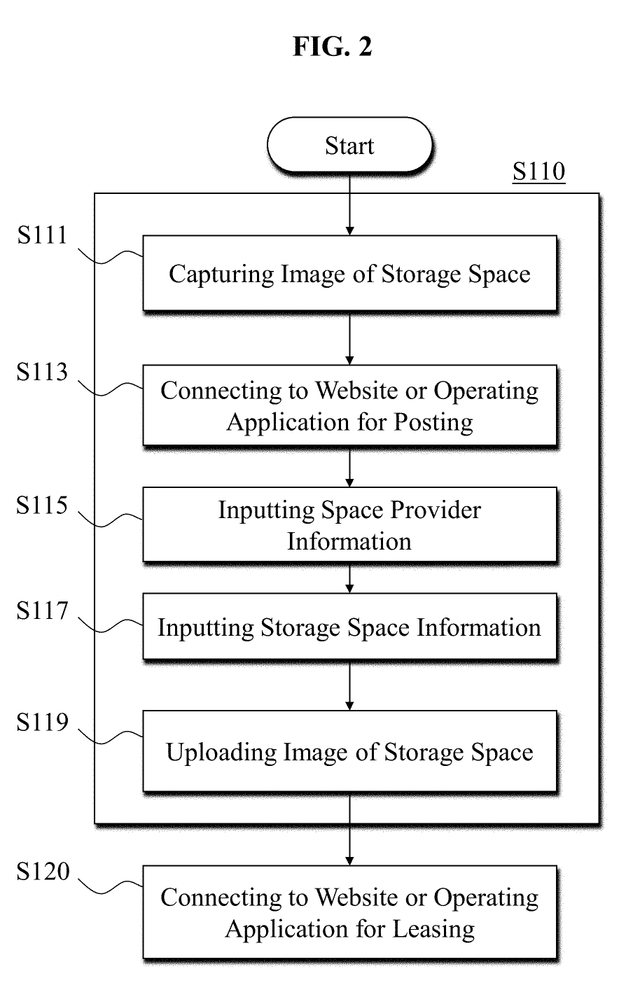

FIG. 2 illustrates the step of posting a storage space in detail. As shown in FIG. 2, the space provider may capture an image for the storage space at step S111 in order to post the storage space. The image will be uploaded in a sharing platform so as to expose the image to potential space users. The sharing platform for exposing the image of the storage space may be a website, in which the space provider posts an advertisement for the storage space and a space user can find the advertisement for the storage space posted therein. The sharing platform for the storage space is not limited to the website, and can include another form, such as an application.

Here, the storage space may include any space or area which can be used for storing a stuff, such as a basement, backyard, attic, aisle, empty room, drive way, parking garage, or parking spot, all of which may belong to a space provider's individual property. The storage space is not limited to them, and may further include, e.g., a stair, a living room, a boiler room, or a closet, which can store items or stuffs, such as a box, furniture, desk, chair, or bicycles. As such, the storage space may include any indoor and outdoor spaces.

The space provider connects to the sharing platform, e.g., a website, in order to post an advertisement for the storage space at step S113. In general, the space provider opens a web browser and inputs an address for a specific website to enter the website. Through the sharing platform, e.g., a website, the user may be able to post the advertisement for the storage space. The sharing platform, e.g., a website, according to an embodiment of the present invention may provided by the space provider or a third party. For example, the website may be managed by a third party, such as a space sharing management center.

Alternatively, the space provider may operate an application to begin the posting of the storage space, which can be performed from a space provider's smart terminal, such as a smart phone. The application may be able to allow the space provider to be connected to the sharing platform or the website through which the space provider can post an advertisement for the storage space. The application can be a form of being embedded in the smart terminal.

It is described using a smart phone as an example of the smart terminal. However, the smart terminal is not limited thereto. The smart terminal according to an embodiment of the present invention may include a smart phone, a cellular phone, a phablet, a tablet, a laptop, a personal computer (PC), or a personal digital assistant (PDA), which can transmit data online when the smart terminal is connected to the internet. For example, the smart terminal can include an electronic device having a memory, a microprocessor for executing, operating, and controlling a program.

Upon connecting to the web site or operating the application, the space provider may be prompted to input space provider information at step S115. The space provider information includes a name, an address, and contact information. In order to input the space provider information, the space provider may log in to the application or the website, when the space provider has an account therein. Otherwise, the space provider may register and create an account to log in to the application or the website. When the space provider has an account therefor, the user may store, in advance, the space provider's information which is associated with the account. Thus, the space provider may avoid the input of the space provider information at this step.

The space provider information may further include other data, such as an occupation, the number of family members, whether or not having a pet, or total annual income. The user information can be used by a space user to determine the space provider.

Also, the space provider may be prompted to input information about the storage space at step S117. The information for the storage space includes a location where the storage space is located, a size thereof, a shape thereof, an objective of the space, a cost for using the storage space, and a period for a lease. The information for the storage space may also include special conditions in terms of using the storage space, including prohibitive items, desired items, or an exemption provision, such as responsibility waiver against damage to the stored items. The information for the storage space is not limited thereto and include other information.

The space provider may also be able to upload the image of the storage space at step S119. The image upload can be performed after the input of the storage space information, before the input of the storage space information, or at the same time as the input of the storage space information.

When the space provider finishes the posting of the storage space, a space user may be able to find the storage space. Hereinafter, it will be described in greater detail how a space user finds a storage space the space provider posted.

As illustrated in FIG. 1, the space user may be able to connect to the website where an advertisement for a storage space was posted by a space provider (step S120). In general, the space user can open a web browser and inputs an address for a specific website to visit the website. Through the website, the user may be able to find the advertisement for the storage space.

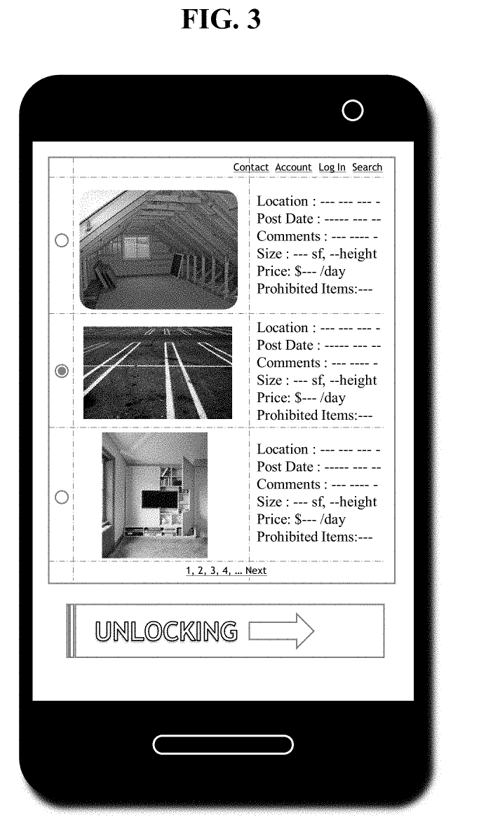

Alternatively, the space user may operate an application to find the storage space. The application can be operated on a space user's smart terminal such as a smart phone. The application may allow the space user to be connected to the website through which the space user can find the advertisement for the storage space. The application can be a form of being embedded in the smart terminal. FIG. 3 is an exemplary screen of a mobile device where an application for finding a storage space is running.

Upon running the application or connecting to the web site, the space user may be prompted to input space user information at step S130. The space user's information includes a name, an address, and contact information. In order to input space user's information at this step, the space user may choose to log in to the application or to the website when the space user has an account therein. Otherwise, the space user may register and create an account to log in to the application or the website. When the user has an account therein, the space user may store, in advance, the space user information which is associated with the account. Thus, the space user may avoid the inputting of user information.

The space user information is not limited to those listed above, and may further include other information, such as an occupation, whether or not having a pet, or total annual income. The space user information may be used by the space provider to determine a lease request transmitted by the space user at a later time.

Thereafter, the space user may search for the storage space he or she needs, and when the space user finds appropriate one that he or she is interested in, the space user may transmit a lease request to the space provider at step S140.

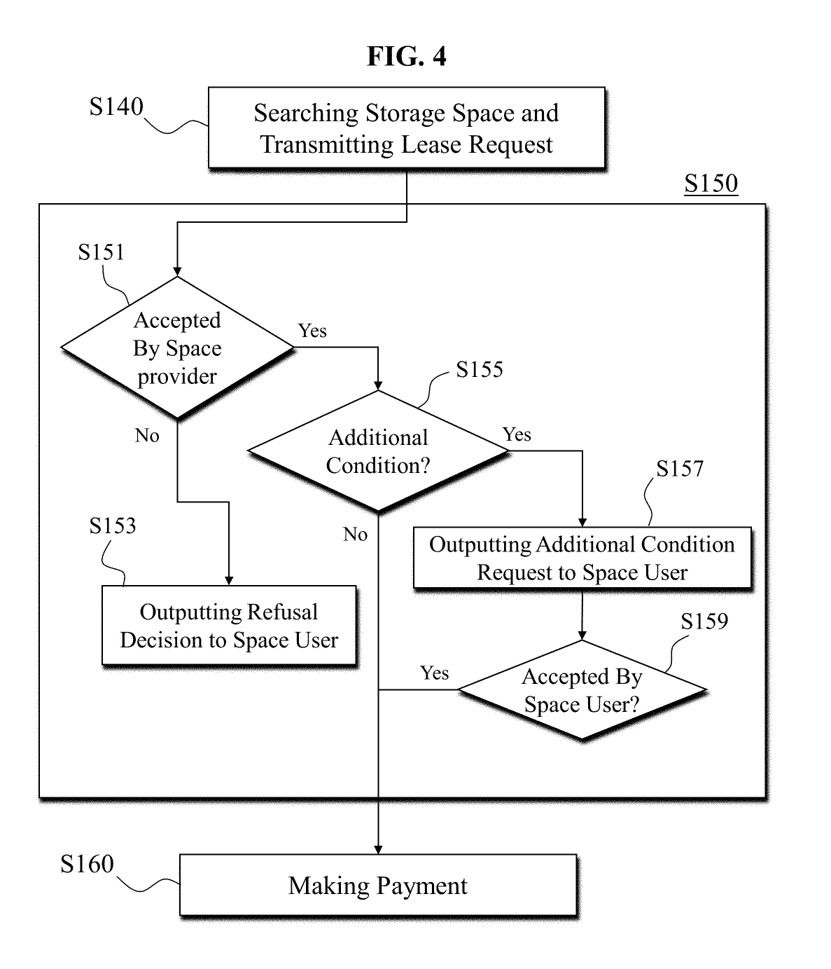

When the request for lease is transmitted to the space provider, the space provider perform a step of determining the lease request at step S150, as show in FIG. 1. The step S150 of determining the lease request is illustrated in FIG. 4.

First, the space provider determines whether or not he or she accepts the lease request transmitted from the space user. If the space provider refuses the lease request, then the decision of refusing the lease request is outputted to the space user (S153). However, if the space provider accepts the lease request from the space user, then it may be determined whether or not there is an additional condition for the lease at step S155.

In the case of no further condition from the space provider, the procedure proceeds to a step of making a payment at step S160. However, if there is additional conditions in relation to the lease, the additional condition request is outputted to the space user for his or her review (S157). From that point, the space user may determine whether he or she accepts the additional condition request at step S159. When the space user accepts the additional condition request, the procedure according to an embodiment of the present invention proceeds to the step of making a payment.

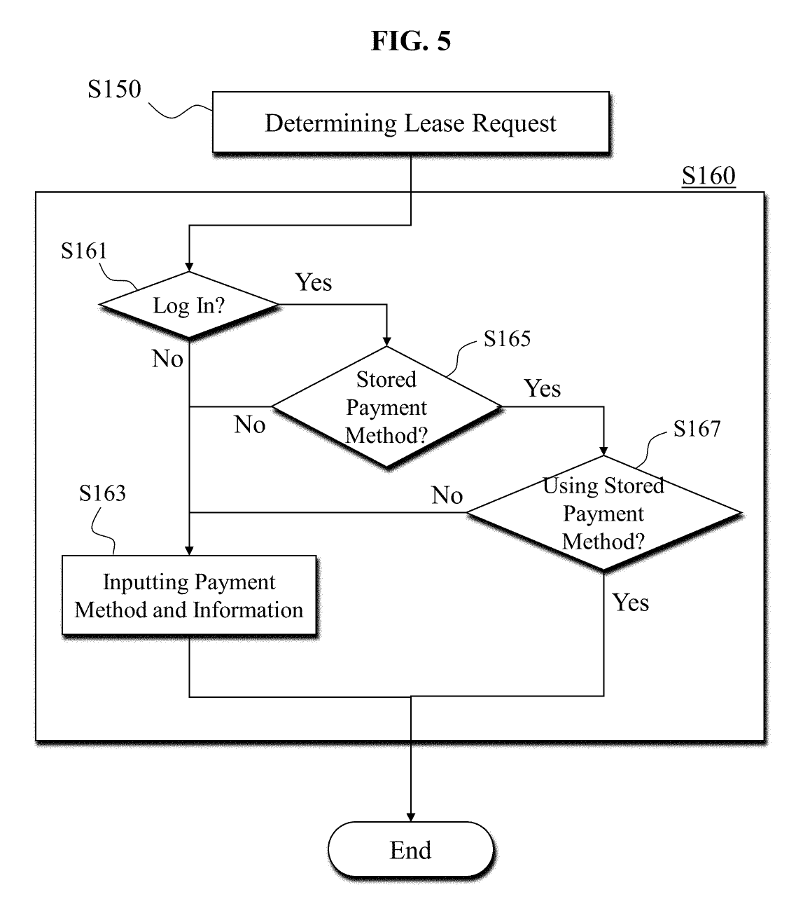

FIG. 5 is a flow chart illustrating the step of making a payment for the storage space according to an embodiment of the present invention. In order to perform the payment, it may be necessary to determine whether or not the space user is logged in to the application or to the website (step S161). When the space user did not log in to the application, the space user may be asked to input a payment method and payment information at step S163. However, if the space user logged in, it is determined whether or not there is a payment method and payment information stored in the user account (step S165). When there is the payment method and information previously stored in the associated space user account, it may be determined whether or not the space user wants to use the stored payment method and information (step S167). In case that there was no payment method and information associated with the user account, or the user refused to use the stored payment method and information to perform the payment, the procedure moves to a step of inputting the payment method and information at step S163.

Exemplary payment methods include a credit card, a wiring, or a check. Corresponding payment information may be the information for the credit card, e.g., a credit card number and effective date, information for conducting the wiring, such as bank information, a routing number, or an account number.

After making a payment, the space user can complete the procedure and the space user may be given a confirmation page or a confirmation message in which the status of the lease request is displayed.

Accordingly, according to the method of the present invention, the space provider can easily post the advertisement for the storage space and the space user can find the storage space conveniently. In addition, the space provider utilizes the unused space efficiently.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of sharing a storage space, the method comprising:
posting, by a space provider, a storage space to a sharing platform;
connecting, by a space user, to the sharing platform where the space user finds the storage space;
transmitting, by a space user, a lease request to the space provider;
determining the lease request by the space provider; and
making a payment by the space user,
wherein the posting of the storage space further comprises:
capturing an image of the storage space;
connecting to the sharing platform where the space provider posts the storage space;
inputting storage space information; and
uploading the image of the storage space to the sharing platform.

2. The method of claim 1, further comprising:
inputting space user information including at least one of a name, an address, contact information, an occupation, or total annual income.

3. The method of claim 1, wherein the posting of the storage space further comprises inputting space provider information including at least one of a name, an address, contact information, an occupation, or total annual income.

4. The method of claim 3, wherein the posting of the storage space comprises operating an application by the space provider, thereby being connected to the sharing platform where the space provider posts the storage space.

5. The method of claim 1, wherein the determining of the lease request comprises:
determining whether or not the space provider accepts the lease request from the space user;
determining whether or not the space provider has an additional condition for the lease request when the space provider accepts the lease request from the space user;
outputting an additional condition request to the space user when the space provider has an additional condition for the lease request; and
determining whether or not the space user accepts the additional condition request,
wherein a refusal decision is outputted to the space user when the space provider does not accept the lease request from the space user.

6. The method of claim 5, wherein the making a payment further comprises:
determining whether or not the space user logged in to the sharing platform;
inputting a payment method and payment information when the space user does not log in to the sharing platform;
determining whether or not there is a payment method and payment information stored in a space user account if the space user logged in to the sharing platform; and
determining whether or not the space user wants to use the stored payment method and information when there is the payment method and information stored in the space user account.

7. The method of claim 4, wherein the sharing platform includes a website.

8. The method of claim 4, further comprising operating an application by the space user, thereby being connected to the sharing platform where the space user finds the storage space.
